(19) United States
(12) Patent Application Publication
(10) Pub. No.: US 2022/0050527 A1
(43) Pub. Date: Feb. 17, 2022

(54) SIMULATED SYSTEM AND METHOD WITH AN INPUT INTERFACE

(71) Applicant: Himax Technologies Limited, Tainan City (TW)

(72) Inventor: Chung-Ju Lee, Tainan City (TW)

(21) Appl. No.: 16/991,657

(22) Filed: Aug. 12, 2020

(51) Int. Cl. G06F 3/01; G06T 11/00

(52) U.S. Cl. CPC G06F 3/017; G06T 11/00; G06F 3/011

(57) ABSTRACT

A simulated system with an input interface includes an image capture device that captures an image of hands of a user; an image generating device that generates a computer-generated image of a keyboard including a plurality of keys; a superimposing device that superimposes the computer-generated image and the captured image; and a tracking device that tracks motion of thumbs of the hands according to a plurality of the superimposed images to determine whether a key stroke is made by the thumb.

### BACKGROUND OF THE INVENTION

### 1. Field of the Invention

The present invention generally relates to an augmented reality device, and more particularly to an input scheme of an augmented reality device.

### 2. Description of Related Art

Augmented reality (AR) is a technology that provides a composite view by superimposing a computer-generated image on a user's view of the real world. AR allows an interactive experience of a real-world environment where the objects that reside in the real world are enhanced by computer-generated perceptual information. In other words, AR is a combination of real and virtual worlds capable of facilitating real-time interaction. Virtual reality (VR) is a simulated experience that may be similar to real world.

A computer keyboard is essential to a computer or a portable electronic device (such as a smartphone) for entering a command or text. As being not convenient to equip an AR device with a keyboard, techniques such as speech recognition that translates a user's spoken words into computer instructions, and gesture recognition that interprets a user's body movements by visual detection or from sensors embedded in a peripheral device have been adopted. Such techniques, however, suffer inaccuracy or complexity.

A need has thus arisen to propose a novel scheme to provide a simple and accurate input interface for the AR device.

### SUMMARY OF THE INVENTION

In view of the foregoing, it is an object of the embodiment of the present invention to provide a simulated system/method such as an augmented reality (AR) or virtual reality (VR) that provides a virtual keyboard as a text entry interface.

According to one embodiment, a simulated system with an input interface includes an image capture device, an image generating device, a superimposing device and a tracking device. The image capture device captures an image of hands of a user, thereby generating a captured image. The image generating device generates a computer-generated image of a keyboard including a plurality of keys. The superimposing device superimposes the computer-generated image and the captured image, thereby generating a superimposed image. The tracking device tracks motion of thumbs of the hands according to a plurality of the superimposed images to determine whether a key stroke is made by the thumb.

### BRIEF DESCRIPTION OF THE DRAWINGS

FIG. 1 shows a block diagram illustrating an augmented reality (AR) system according to one embodiment of the present invention;

FIG. 2 shows a flow diagram illustrating an augmented reality (AR) method according to one embodiment of the present invention;

FIG. 3 shows an example of the superimposed image, on which the keys are properly positioned on the index fingers, middle fingers, ring fingers, and little fingers, respectively;

FIG. 4A schematically shows smart glasses with the display and the image capture device for capturing the image of hands;

FIG. 4B exemplifies user's field of view through the display;

FIG. 5A to FIG. 5C show an example of making a key stroke by the thumb of the left hand; and

FIG. 6 shows a series of making key strokes and associated keys to be outputted.

### DETAILED DESCRIPTION OF THE INVENTION

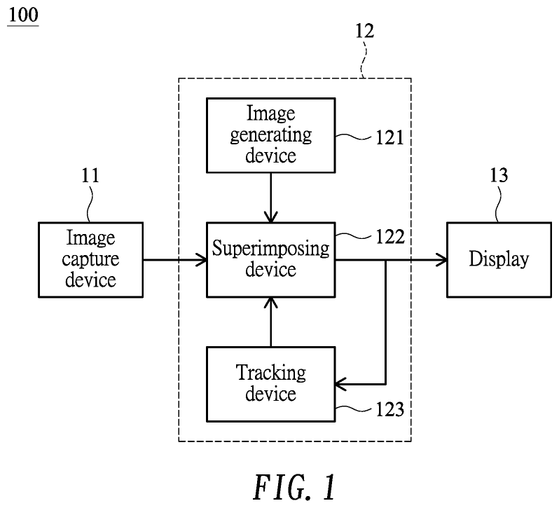

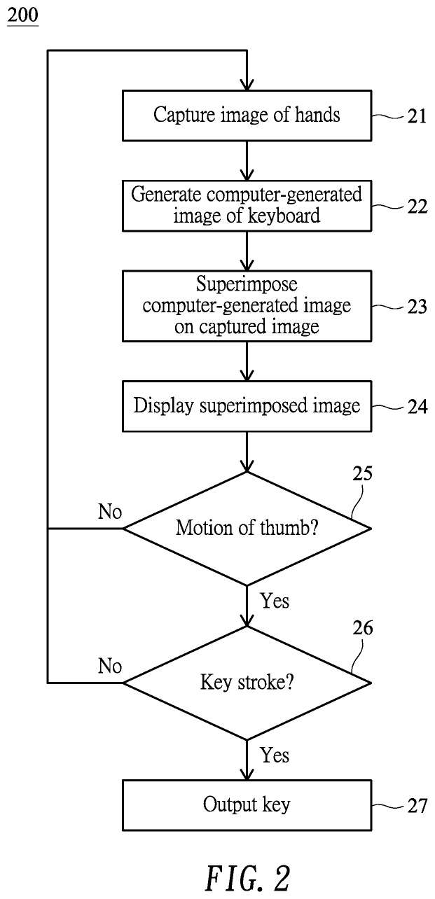

FIG. 1 shows a block diagram illustrating an augmented reality (AR) system 100 according to one embodiment of the present invention, and FIG. 2 shows a flow diagram illustrating an augmented reality (AR) method 200 according to one embodiment of the present invention. It is appreciated that blocks of the AR system 100 and steps of the AR method 200 may be performed by hardware, software or their combinations, such as a digital image processor. In one embodiment, the AR system 100 may be disposed on a wearable device such as a head-mounted display or smart glasses. Although AR system 100 or AR method 200 is described in the embodiment, it is appreciated that the invention may be adaptable to a virtual reality (VR) system or method. In general, the invention may be adaptable to a simulated system/method such as AR or VR.

In the embodiment, the AR system 100 may include an image capture device 11 such as a two-dimensional (2D) camera, a three-dimensional (3D) camera or both. The image capture device 11 of the embodiment may be configured to capture an image of hands of a user, thereby generating a captured image of user's field of view (step 21). In the embodiment, the image capture device 11 may repetitively or periodically capture images at regular time intervals. In a VR system or method, a virtual image of hands of the user may be generated according to the captured image.

The AR system 100 of the embodiment may include an image generating device 121 (in a processor 12) configured (in step 22) to generate a computer-generated image of a (computer) keyboard including a plurality of keys (e.g., alphabetic, numeric, and punctuation symbols). The layout (or arrangement) of the keys may be a standard layout (e.g., QWERTY layout) or a specialized (or user-defined) layout. In the embodiment, the image generating device 121 may generate a 3D point cloud including a set of data points by scanning a plurality of points on external surfaces of the hands.

In the embodiment, the AR system 100 may include a superimposing device 122 (in the processor 12) configured to superimpose the computer-generated image (from the image generating device 121) and the captured image (from the image capture device 11), thereby generating a superimposed image (step 23). In a VR system or method, the computer-generated image (of the keyboard) may be superimposed on the virtual image of hands.

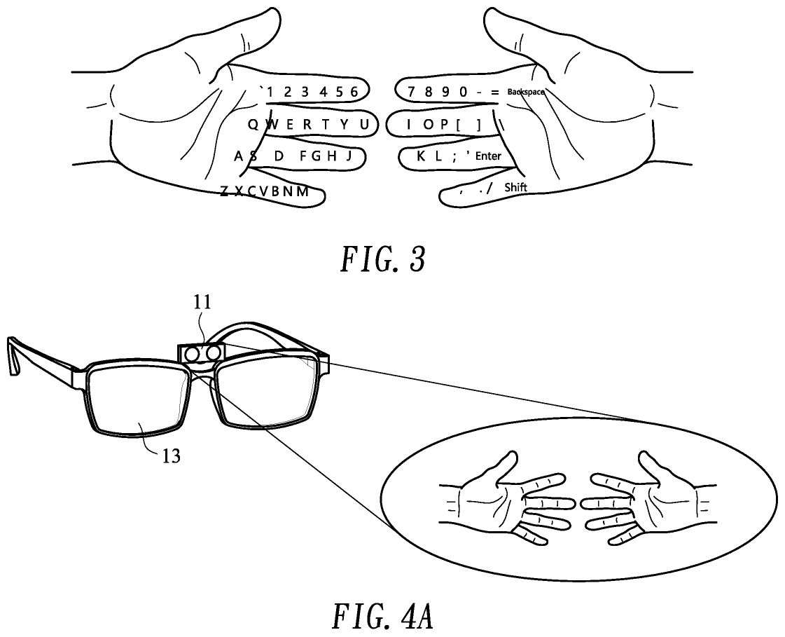

In the embodiment, the superimposing device 122 may adopt an artificial intelligence (AI) engine configured to position (or place) the keys (e.g., alphabetic, numeric, and punctuation symbols) of the computer-generated image on fingers (particularly index fingers, middle fingers, ring fingers, and little fingers) of the hands of the captured image. FIG. 3 shows an example of the superimposed image, on which the keys are properly positioned on the index fingers, middle fingers, ring fingers, and little fingers, respectively.

In one embodiment, depth information of the 3D image may be utilized to make the arrangement of the keys on the fingers by segmenting the fingers according to (flat) phalangeal parts and (wrinkled and valley-like) interphalangeal joints, which provide distinct image characteristics that facilitate detection and tracking in the following steps. It is appreciated that more keys may be arranged on the fingers if more depth information may be obtained and utilized.

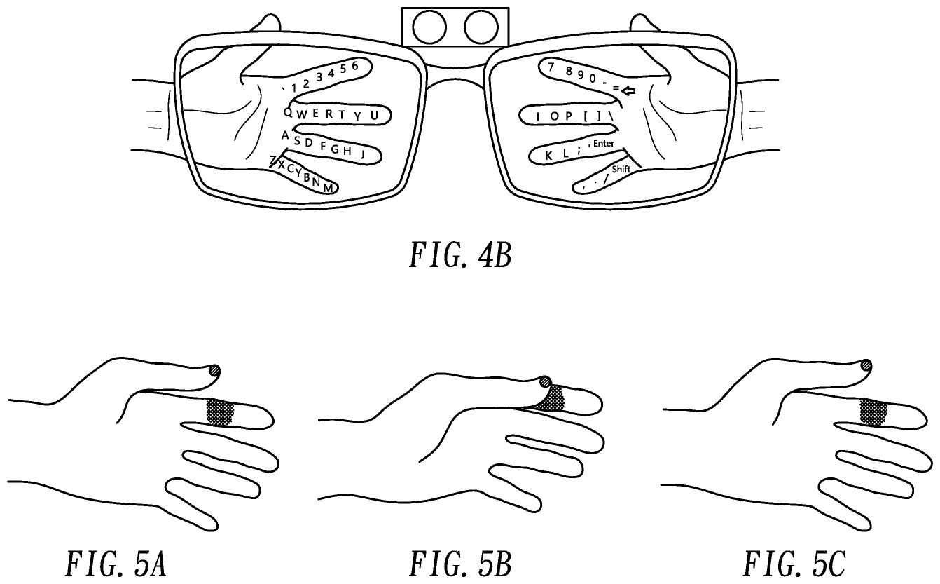

The AR system 100 of the embodiment may include a display 13 configured to present (or display) the superimposed image (from the superimposing device 122) for the user. The display 13 may, for example, transparent lenses of the smart glasses. FIG. 4A schematically shows smart glasses with the display 13 and the image capture device 11 for capturing the image of hands. FIG. 4B exemplifies user's field of view through the display 13. In another embodiment, the display 13 may include a retinal display or projector that displays the superimposed image directly onto the retina of the user's eye.

In the embodiment, the AR system 100 may include a tracking device 123 (in the processor 12) capable of motion capturing to track motion of thumbs of the hands according to a plurality of superimposed images (step 25). If no motion of the thumb is tracked, the flow goes back to step 21. Otherwise, the tracking device 123 may determine, in step 26, whether a key stroke is made by the thumb(s).

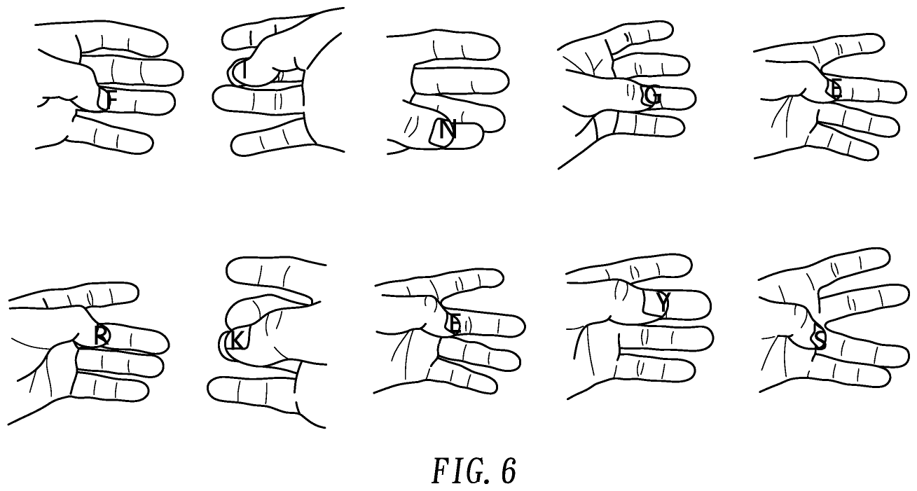

Specifically, a key stroke is made when the thumb moves toward a key, followed by moving away the key. FIG. 5A to FIG. 5C show an example of making a key stroke by the thumb of the left hand. Specifically, the thumb as shown in FIG. 5A moves toward the key “4” (FIG. 5B), followed by moving the thumb away the key “4” (FIG. 5C). Therefore, the key “4” may be determined as being made. It is appreciated that a key stroke may be made by both thumbs. For example, when the right thumb strokes the key “SHIFT” and the left thumb strokes the key “a,” a key “A” may be determined as being made. To facilitate operations for the user, tips of the thumbs of the hands may be further marked (by the image generating device 121) with pointers (e.g., bright dots), and the key to which the thumb is close may be highlighted. After the tracking device 123 determines the key stroke, an associated key (e.g., alphabetic, numeric, and punctuation symbol) may then be outputted (step 27). FIG. 6 shows a series of making key strokes and associated keys to be outputted.

Although specific embodiments have been illustrated and described, it will be appreciated by those skilled in the art that various modifications may be made without departing from the scope of the present invention, which is intended to be limited solely by the appended claims.

What is claimed is:

1. A simulated system with an input interface, comprising:
an image capture device that captures an image of hands of a user, thereby generating a captured image;
an image generating device that generates a computer-generated image of a keyboard including a plurality of keys;
a superimposing device that superimposes the computer-generated image and the captured image, thereby generating a superimposed image; and
a tracking device that tracks motion of thumbs of the hands according to a plurality of the superimposed images to determine whether a key stroke is made by the thumb.

2. The system of claim 1, wherein a virtual image of hands is generated according to the captured image.

3. The system of claim 2, wherein the computer-generated image is superimposed on the virtual image to generate the superimposed image.

4. The system of claim 1, wherein the image generating device generates a three-dimensional point cloud including a set of data points by scanning a plurality of points on external surfaces of the hands.

5. The system of claim 1, wherein the superimposing device positions the keys of the computer-generated image on index fingers, middle fingers, ring fingers or little fingers of the hands of the captured image.

6. The system of claim 5, wherein depth information of the captured image is utilized to make arrangement of the keys on fingers of the hands by segmenting the fingers according to phalangeal parts and interphalangeal joints.

7. The system of claim 1, further comprising:
a display that presents the superimposed image for the user.

8. The system of claim 7, wherein the display comprises transparent lenses of smart glasses.

9. The system of claim 7, wherein the display comprises a retinal projector that displays the superimposed image directly onto retina of user's eye.

10. The system of claim 1, wherein the key stroke is determined as being made when the thumb moves toward a key, followed by moving away the key.

11. A simulated method with an input interface, comprising:
capturing an image of hands of a user to generate a captured image;
generating a computer-generated image of a keyboard including a plurality of keys;
superimposing the computer-generated image and the captured image to generate a superimposed image; and
tracking motion of thumbs of the hands according to a plurality of the superimposed images to determine whether a key stroke is made by the thumb.

12. The method of claim 11, wherein a virtual image of hands is generated according to the captured image.

13. The method of claim 12, wherein the computer-generated image is superimposed on the virtual image to generate the superimposed image.

14. The method of claim 11, wherein a three-dimensional point cloud including a set of data points is generated by scanning a plurality of points on external surfaces of the hands.

15. The method of claim 11, wherein the keys of the computer-generated image are positioned on index fingers, middle fingers, ring fingers or little fingers of the hands of the captured image.

16. The method of claim 15, wherein depth information of the captured image is utilized to make arrangement of the keys on fingers of the hands by segmenting the fingers according to phalangeal parts and interphalangeal joints.

17. The method of claim 11, further comprising:
presenting the superimposed image for the user.

18. The method of claim 17, wherein the superimposed image is presented by transparent lenses of smart glasses.

19. The method of claim 17, wherein the superimposed image is presented by a retinal projector that displays the superimposed image directly onto retina of user's eye.

20. The method of claim 11, wherein the key stroke is determined as being made when the thumb moves toward a key, followed by moving away the key.
